(19) United States
(12) Patent Application Publication
(10) Pub. No.: US 2020/0150709 A1
(43) Pub. Date: May 14, 2020

(54) DEVICE AND SYSTEM FOR CONTROLLING A TRANSPORT VEHICLE

(71) Applicant: RED MILAWA PTY LTD, Noble Park (AU)

(72) Inventor: Tilo SCHMIDT, Noble Park (AU)

(21) Appl. No.: 16/739,061

(22) Filed: Jan. 9, 2020

Related U.S. Application Data
(63) Continuation of application No. 15/105,490, filed on Jun. 16, 2016, now abandoned.

(30) Foreign Application Priority Data
Dec. 17, 2013 (AU) 2013904918

(51) Int. Cl. G05G 9/047; A61G 5/04

(52) U.S. Cl. CPC G05G 9/047; A61G 5/04; B62B 5/0069; A61G 2203/14; G05G 2009/04762; A61G 5/048

(57) ABSTRACT

A controller for operative connection to a power assisted transport vehicle that is at least partially directed by a human operator in physical contact with the vehicle, the controller including: a contact surface, a first sensor and a second sensor each responsive to manual actuation of the contact surface, each sensor having a respective first sensor output signal and a second sensor output signal, and a signal processing means adapted to process the first and second output signals, wherein force imparted to the contact surface in the Z-axis is adapted to provide Z-axis movement of the vehicle by processing the first sensor output signal and the second sensor output signal, and wherein force imparted to the contact surface in the X-axis is adapted to provide X-axis movement of the vehicle by processing the first sensor output signal and the second sensor output signal.

### CROSS REFERENCE TO RELATED APPLICATIONS

The present application is a continuation of U.S. Non-provisional Application No. 15/105,490 entitled “DEVICE AND SYSTEM FOR CONTROLLING A TRANSPORT VEHICLE,” filed on Jun. 16, 2016. U.S. Non-provisional Application No. 15/105,490 is a U.S. National Phase of International Patent Application Serial No. PCT/AU2014/001127 entitled “DEVICE AND SYSTEM FOR CONTROLLING A TRANSPORT VEHICLE,” filed on Dec. 16, 2014. International Patent Application Serial No. PCT/AU2014/001127 claims priority to Australian Patent Application No. 2013904918, filed on Dec. 17, 2013. The entire contents of each of the above-cited applications are hereby incorporated by reference in their entirety for all purposes.

### FIELD OF INVENTION

The present invention relates to the field of operation of vehicles for transporting people or a payload. In particular the present invention relates to operation of vehicles that are partially or fully directed by a human operator, such as trolleys and wheelchairs.

In one form, the invention relates to a force responsive sensor controller for a transport vehicle that is at least partially directed by a human operator.

In another form, the invention relates to a method of operating a transport vehicle using a force responsive sensor controller.

It will be convenient to hereinafter describe the invention in relation to operation of a wheelchair. However, it should be appreciated that the present invention is not limited to that use only and can be applied to a wide range of transport vehicles.

### BACKGROUND ART

It is to be appreciated that any discussion of documents, devices, acts or knowledge in this specification is included to explain the context of the present invention. Further, the discussion throughout this specification comes about due to the realization of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Many types of vehicles exist today for the purpose of transporting a person or payload. Many are manually operated, that is, they are not power assisted and require the operator to hold onto handles to push and pull the vehicle and guide it in the desired direction. Examples of this type of vehicle include luggage trolleys, mobile patient beds and wheelchairs.

With reference to wheelchairs, an attendant often walks behind, pushing handles located behind a seat of the wheelchair. If the wheelchair is moving along a downward slope, the attendant must pull the handles to avoid uncontrolled acceleration. If the wheelchair is moving along an upward slope the attendant must push the handles. The physical stress on the attendant or operator can cause injuries and it is therefore becoming more acceptable to add some form of power assisted drive mechanism to wheelchairs to limit the strain imposed on the operator.

Vehicles such as forklifts, wheelchairs and trolleys typically have a joystick or throttle type twist grip to control the movement of the vehicle. Joystick and twist grip throttle controls are commonly available and require little if any training to use. However, joysticks are particularly difficult to master in applications where an operator walks behind a vehicle and they lack robustness because they include a number of moving parts that are prone to breakage. Twist grip throttle controls have the drawback of having a number of moving parts that can jam and require substantial ongoing maintenance to work smoothly.

One example of control devices of the prior art is described in U.S. Pat. No. 6,738,691 (Colgate et al) which relates to a control handle for intelligent assist device, robot or other powered system that is partially for fully directed by a human operator. The operation of the control handle is based on using a plurality of sensors to measure the force, torque or motion imparted by the human operator. It relates primarily to the control of a powered manipulation and positioning device such as an overhead crane for lifting and manipulation of a payload, in contradistinction to control or steering of a vehicle.

US patent application 2007/0284845 (Roovers et al) relates to a wheel chair with drive support and hand force sensor. The hand force sensor comprises a force sensitive sensor part and a spring system which, during use, transmits hand force from a grip or wheel on which the hand force is applied to the force sensor. The spring system comprise two biased springs between which is a receive element that transmits the hand force to the spring system. However, there is a degree of inaccuracy inherent in the way this system responds to forces imparted by a hand onto the grip or wheel. For example, this system is not well adapted for control when the force of one hand (instead of both hands) is imparted to the wheel chair, or when the hand applies a backwards pulling force to reverse or tip the wheel chair to traverse a step.

British patent 2479555 (Freeman) relates to a wheelchair having a power assist device that includes devices for measuring force applied to propulsion apparatus that drive the wheels. The drive provided to the wheels is proportional to force applied manually to the propulsion apparatus. A controller provides drive signals which are proportional to the measured forces applied to the handgrips on the handles of the wheelchair.

However one of the problems associated with this device is that it does not properly resolve all of the forces applied to the handles. For example, using two handles it is possible to steer the wheelchair, however it is not possible to steer the chair when using only one handle as is often required when holding open a door with one hand while maneuvering the chair with the other hand. Again, there is a degree of inaccuracy inherent in the way this system responds to forces imparted on the handles, particularly when the operator pushes downward or upwards on the handles this will be incorrectly resolved as a backward or forward force on the handles respectively.

### SUMMARY OF INVENTION

An object of the present invention is to provide a controller device that is safe, simple and intuitive to use.

Another object of the present invention is to provide a controller device that allows direction and speed of travel to be controlled with just one hand.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a controller for operative connection to a power assisted transport vehicle that is at least partially directed by a human operator in physical contact with the vehicle, the controller including:
a contact surface,
a first sensor and a second sensor each responsive to actuation of the contact surface each sensor having a respective first sensor output signal and a second sensor output signal, and
a signal processing means adapted to process the first and second output signals, wherein force imparted to the contact surface in the Z-axis is adapted to provide Z-axis movement of the vehicle by processing the first sensor output signal and the second sensor output signal, and wherein force imparted to the contact surface in the X-axis is adapted to provide X-axis movement of the vehicle by processing the first sensor output signal and the second sensor output signal.

The contact surface may be of any conformation suitable for actuation by force imparted from a body part of a human operator. The force may be imparted, for example, from the operator's hand, finger, head, arm (such as the elbow), shoulder or leg (such as the knee or ankle) and the contact surface appropriately configured for convenient use with the body part. Preferably the contact surface comprises a handle, joystick, contact pad or headrest appropriately contoured for contact with a specific body part.

Typically the actuation comprises input in the form of force and/or movement imparted by the human operator. In one embodiment the movement in the X-axis direction and/or the Z-axis direction is proportional to the force imparted to the contact surface in the respective X-axis direction and/or the Z-axis direction.

Thus, when the controller is being subjected to manual control, manual force by one hand on a single contact surface can be detected by the sensors and resolved by the signal processing means into spatial components in two dimensions (relative to an X-axis and Z-axis) to control the direction and speed of the vehicle, leaving the operator's other hand free if required. In a preferred embodiment the first and second sensors are responsive to a single handle. In an alternative embodiment, two handles may be utilized with the forces applied to the handles being resolved by the signal processing means. Accordingly, in another embodiment, the controller includes a third sensor and a fourth sensor each responsive to actuation of a further handle, the signal processing means being adapted to process output signals of all four sensors.

The signal processor is typically some form of logic means used to calculate resolution of the output signals from the sensors into component forces and to apply control algorithms to the signals to ensure smooth and safe control of the vehicle. For example, when the vehicle is being manually controlled by a control handle, the control handle may additionally include a safety mechanism that only allows the vehicle to operate if the operator is holding on to at least one control handle. This might consist of a mechanical switch lever that the operator must activate while in control of the vehicle (commonly known as a “deadman” switch) or some other sensor type to detect the presence of the operator's hand on the control handle.

The present invention thus provides the ability to steer and control the drive assistance mechanism directly through manual actuation of a single contact surface such as a handle, ordinarily used for manually pushing the vehicle. In contrast, similar controllers of the prior art require both handles to be actuated to steer.

In a second aspect of embodiments described herein there is provided a transport vehicle comprising the controller of the present invention.

In one preferred embodiment of the controller of the present invention, the contact surface may appear similar to a joystick control of the prior art except that its operation is based on the force applied to the control handle rather than positional movement. For example, using the controller of the present invention, it is possible to push the joystick in the desired direction of vehicle travel—the harder the operator pushes, the faster the vehicle moves.

The controller can also be used in applications where the drive system provides assistive force rather than a set speed. This can, for example be useful for wheelchair applications to multiply the force applied to the control. This effectively reduces the force required to push the wheelchair thereby reducing the strain on the operator. In contrast, forklifts, wheelchairs, trolleys of the prior art included a joystick or throttle type twist grip to control the movement of the vehicle along with other mechanical moving parts.

In the case of a wheelchair, actuation force, such as manual force, may be applied to the controller by the occupant of the wheelchair or an assistant, such as someone pushing the wheelchair. Thus, for example, using a single handle on the controller, an operator seated in the wheelchair, or walking beside or behind the wheelchair can control the steering and drive speed in both forward and reverse directions.

The ground engaging members may be any convenient mobility device such as wheels, casters, rollers or tracks.

In other types of vehicles force applied to the contact surface may optionally control functions of components other than the ground engaging members. Further sensors may be added to achieve this. For example, it could control the upward and downward motion of a fork in a forklift vehicle.

The contact surface is in operative engagement with one or more sensors which generate output signals in response to the application of actuation force. The location and physical arrangement of the sensors must be such that the forces in the various planes can be independently resolved. The number of sensors used matches the number of dimensions in which movement is required.

The proper resolution of these forces so that force on controller in the X- axis direction is reflected by vehicle movement in the X-axis direction, and that force on the contact surface in the Z-axis direction is reflected by vehicle movement in the Z-axis direction distinguishes the controller of the present invention from controllers of the prior art that do not exclude other forces. Controllers of the prior art can have forces in the X, Y and Z-axes simultaneously contributing to movement in the X-axis direction.

Typically the sensors are of any type suitable for measuring force. For example, suitable sensors include load cells, piezoelectric devices, pressure sensing resistors or any other suitable force/pressure sensing element. The sensors are arranged within the control handle in a manner that allows the forces manually applied to the contact surface of the controller to be independently resolved into component forces in each of the relevant axes.

The forces acting on the handle and detected by the sensors are resolved by a logic means into spatial components. The forces may be coplanar thus resolved in two dimensions relative to coordinate Z and X axes. Alternatively, they may be resolved into any or all of the 6 available degrees of freedom if the forces are concurrent, parallel, non-concurrent, non-parallel or rotational.

Where used herein, it is intended that reference to the X-axis means the direction parallel to the ground surface and at right angles to the direction of travel of the vehicle; reference to the Z-axis means the direction parallel to the ground surface and parallel to the direction of travel; and reference to the Y-axis means the direction perpendicular to both the X and Z axes.

Signals resolved in the X-axis direction would typically be used to steer the vehicle left and right. Signals resolved in the Z-axis would typically be used to set the vehicle drive speed and direction (forward and reverse).

In a further embodiment, signals resolved in the Y-axis and components resulting from resolution of rotational force could control other functions such as lifting or tilting a component of the vehicle. Accordingly, in this embodiment the controller would comprise a further sensor, wherein force imparted to the contact surface in the Y-axis is adapted to provide a further sensor output signal to enable Y-axis movement of at least part of the vehicle or another predetermined function of operation.

The sensor output signals are amplified and calculated using a connected electronic signal processor before being applied to the motive device - typically motor controllers of drive motors. The signal processor applies algorithms to the signals to ensure that the control of the vehicle is intuitive, safe and easy. In most cases the operator would notice that the vehicle simply has a “lighter” feel with respect to control and movement as compared with having no power assistance device.

The present invention could be used for operation of a wide range of vehicles including, for example, electric wheelchairs, forklifts of the “walk-behind” type and others, luggage trolleys, goods trolleys, golf bag buggies. In particular, with reference to wheelchairs the controller may be used by a wheelchair user or the carer who walks behind, propelling the wheelchair by pushing or pulling handles provided behind the seat of the wheelchair.

In yet a further aspect of embodiments described herein there is provided a method of controlling a power assisted transport vehicle that is at least partially directed by a human operator in physical contact with the vehicle using the controller of the present invention, the method including the step of applying force to the contact surface to control the direction and speed of the vehicle.

Other aspects and preferred forms are disclosed in the specification and/or defined in the appended claims, forming a part of the description of the invention.

In essence, embodiments of the present invention stem from the realization that having force sensors in direct interaction with a contact surface such as a control handle provides a significantly improved resolution of forces and concomitantly better directional control by an operator. The present invention can properly resolve all the forces imparted to a handle in the Z and X directions (and optionally the Y direction and rotation) to accurately control the direction of movement of a vehicle. In particular, the present invention differs from the prior art by more accurately measuring and resolving all of the forces imparted to one or more control handles by an operator.

The forces include those relevant to control of the wheelchair including for example, torque or the twisting action that is required while driving the wheelchair with one hand only. Another action that is typically imparted by an operator on a manual wheelchair and can be resolved by the controller is the action of tipping the wheelchair backwards while driving in the forwards direction. This might happen, for example, when trying to clear the front castors over a step or gutter. This action generally involves the operator pulling back on the handles to tip the chair backwards. The controller of the present invention is able to differentiate between pulling back on the contact surface of handles to tip the chair backwards and pulling back on the contact surface of handles to drive the chair backwards in the normal manner.

Advantages provided by the present invention comprise the following:
it provides an operator with a robust control input device for driving and controlling a vehicle, such as an electrically controlled vehicle;
it is more intuitive than controllers of the prior art, requiring little, if any, operator skill or training;
allows the vehicle to be operated by an attendant in a manner that is almost identical to vehicles fitted with controllers of the prior art but with greater maneuverability and more intuitiveness and none of the inherent drawbacks associated with the improper resolution of the control forces acting on the control surface;
improved reliability and safety due to a minimum of moving parts;
can be retrofitted to existing vehicles to improve performance;
requires less than 20 kg of force to operate as stipulated by many work safety regulatory authorities;
can be used in a wide range of practical situations and locations;
will operate reliably over non-ideal terrain including ramps and uneven ground.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates in perspective view an example of the physical layout of a controller according to the present invention;

FIG. 2 illustrates in cross-sectional plan view one embodiment of a controller according to the present invention in side view (FIG. 2A), top view (FIG. 2B), schematic view (FIG. 2C) and perspective view (FIG. 2D);

FIG. 3 illustrates in perspective view a further embodiment of a controller according to the present invention in side view (FIG. 3A) and top view (FIG. 3B);

FIG. 4 illustrates three different applications of the controller according to the present invention, for a wheelchair (FIG. 4A), a luggage trolley (FIG. 4B) and a forklift (FIG. 4C).

FIG. 5 illustrates one embodiment of the handle of the present invention with bracket in perspective view (FIG. 5A), side view (FIG. 5B) and plan view (FIG. 5C);

FIG. 6 illustrates an embodiment of a double ended loadcell assembly for the present invention in perspective view (FIG. 6A), top view (FIG. 6B) and side view (FIG. 6C);

FIG. 7 illustrates operation of the handle depicted in FIG. 6;

FIG. 8 illustrates the operation of a further embodiment of device according to the present invention;

FIG. 9 illustrates an embodiment of a head operated controller according to the present invention in perspective view (FIG. 9A), top view (FIG. 9B) and side view (FIG. 9C).

### DETAILED DESCRIPTION

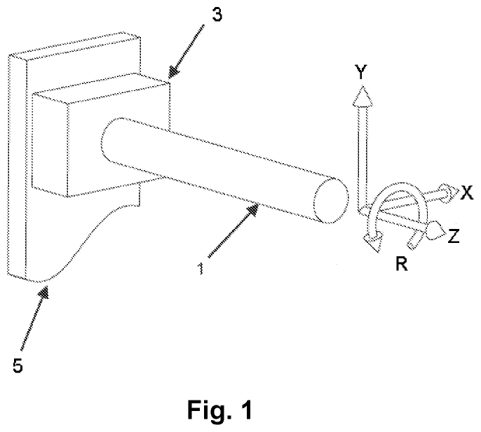

FIG. 1 illustrates an example of the physical layout of a controller according to the present invention.

The controller includes a contact surface in the form of a handle (1) which is attached to one or more force sensors (not shown) within the housing (3), and a signal processor (not shown) that processes electrical signals from the force sensors using an appropriate algorithm to generate a drive signal for the motor driving ground engagement means such as wheels. The sensor housing (3) is supported via a mounting bracket (5) on the motorized base.

In this embodiment the force sensors are load cells, but other embodiments may include pressure sensing resistors or any other suitable force or pressure sensing element. The load cells are arranged within the control handle in a manner that allows the forces applied to the control handle to be independently resolved into component forces indicated in each of the relevant axes X, Y, Z with R indicating rotational force.

The controller allows an operator walking beside or behind a power assisted vehicle to control the drive speed; forward and reverse; and the steering (and possibly additional functions) of the vehicle. An attendant can operate the controller in a way that is almost identical to operating vehicles of the prior art.

The mechanical arrangement of the sensors is such that the forces on the handle are able to be resolved into the component forces in the relevant axes. This can best be explained by way of examples:

Example 1: Two contact surfaces in the form of control handles (each as depicted in FIG. 1) are fitted to the back of a power assisted wheelchair. The attendant grips a handle with each hand and pushes in the direction of the Z-axis to make the chair move in the forward direction. If, as is common, the attendant also leans on the handles while pushing the chair, another force is applied to the handles in the downward direction. The total resultant force and direction is now no longer just in the desired Z-axis direction.

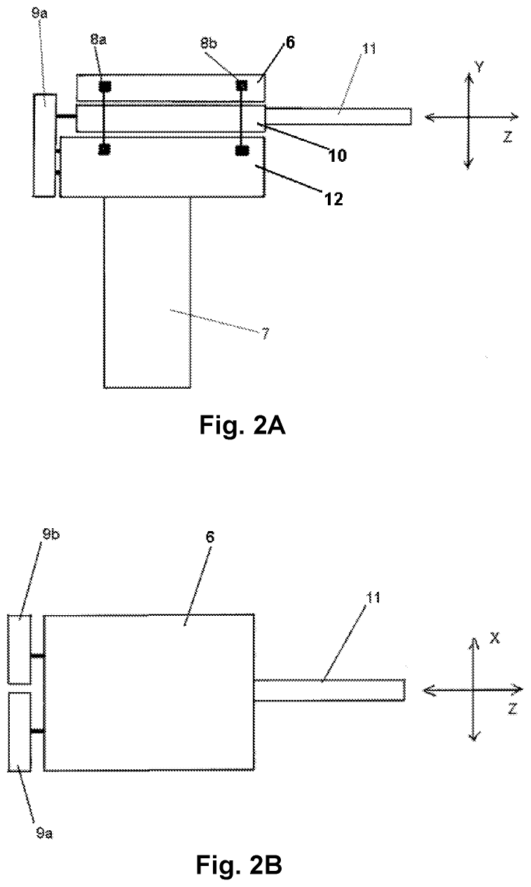

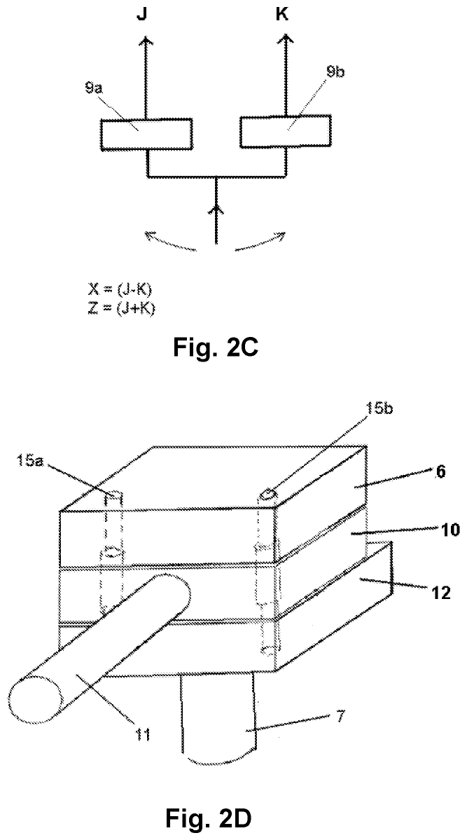

Using this conformation of the controller, there are two preferred embodiments; (a) the signal from the sensor is such that either the attached controller can separate the signals into the relevant directions and thus be able to ignore the unwanted forces due to leaning on the handles (or use them to control other functions) or (b) the mechanical arrangement of the contact surface of the handle is such that the unwanted force from leaning on the handles can be isolated (as shown in FIGS. 2A and 2B).

Example 2: Again with reference to two controllers as depicted in FIG. 1, the attendant might need to carry a bag in one hand and push the wheelchair using the other hand. To accomplish this, the attendant will intuitively push on the contact surface in the form of a handle in the Z-axis direction to move the chair forward, but would also twist the handle in the X-axis direction to maintain a straight course or to steer around corners when required. The controller will therefore need to resolve the independent component forces in the Z and X axes to control the wheelchair correctly.

The mechanical arrangement of the contact surface and the force sensors is such that the attached controller is able to resolve forces in the X-axis—to steer the vehicle left/right—and in the Z-axis—to control the forward/reverse speed. The signals proportional to the forces applied in the Y-axis and the rotational forces R might also be used by the attached controller to control other functions of the power assisted vehicle.

The signals resolved in the X-axis will be used to steer the motorized base vehicle left and right. The signals resolved in the Z-axis direction will be used to set the drive speed and direction (forward and reverse).

In one preferred embodiment, the signal resolved for the Y-axis direction and the ‘R’ rotational direction are used to control other functions such as lift and/or tilt where appropriate.

The location and physical arrangement of the sensors must be such that the forces in the various axes can be independently resolved. One preferred embodiment for achieving this is depicted in FIG. 2A which illustrates a side view of a controller showing preferred locations of the sensors so that the forces in the various planes can be independently resolved.

Specifically FIG. 2A depicts three plates (6,10,12). The plates may be metal, or constructed of any other convenient materials or combinations of materials. Two of the plates (6, 12) are attached to a support (7) on the vehicle, such as the handle of a wheelchair. The middle plate (10) is attached to a first sensor (9a) and contact surface of the handle (11) and has a small degree of freedom to slide relative to the upper and lower plates (6, 12), subject to the application of the bolts (8a,8b). The first sensor (9a) and second sensor (9b) are attached between two of the plates (10, 12). The first sensor (9a) and second sensor (9b) will therefore measure the forces in the X and Z axial directions only and remain unaffected by forces imparted in the Y-axis direction. As in example 1 above, leaning on the handles has no effect on the control forces in the X or Z-axes.

FIG. 2B illustrates a top plan view of the controller of FIG. 2a. In this view the first sensor (9a) and the second sensor (9b) can both be seen, along with the handle (11) and the upper plate (6).

FIG. 2C illustrates the effects of manual force imparted to the handle (11) of the controller of FIG. 2A. If the signals from the first and second sensors (9a) and (9b) are J and K respectively then with the first sensor (9a) and the second sensor (9b) mounted as shown, the resultant signal for forces in directions Z (for forward/reverse) and X (left/right) will be: Z=J+K and X=J−K.

FIG. 2D illustrates the ‘sandwich’ structure of the plates (6, 10, 12) and handle (11) in isolation. The plates are held together by two bolts (8a, 8b—not shown in this view) that are located in holes (15a, 15b) that pass through all three plates. The diameter of the holes (15a, 15b) is slightly greater where it passes through the second plate (10), as compared with the other two plates (6, 12). Thus, slight movement of plate 10 relative to plates 6 and 12 is permitted in the horizontal plane and this is sufficient for operation of the force sensors (9a) and (9b). In other vehicles such as forklifts, it may be useful to have a mechanical arrangement that also allows measurement of the vertical forces in the Y axis of the middle plate (10) relative to the other plates (6, 12). This could be achieved for example by including one or more load cells to measure the Y axis forces that the middle plate (10) exerts on the top plate (6) or the bottom plate (12).

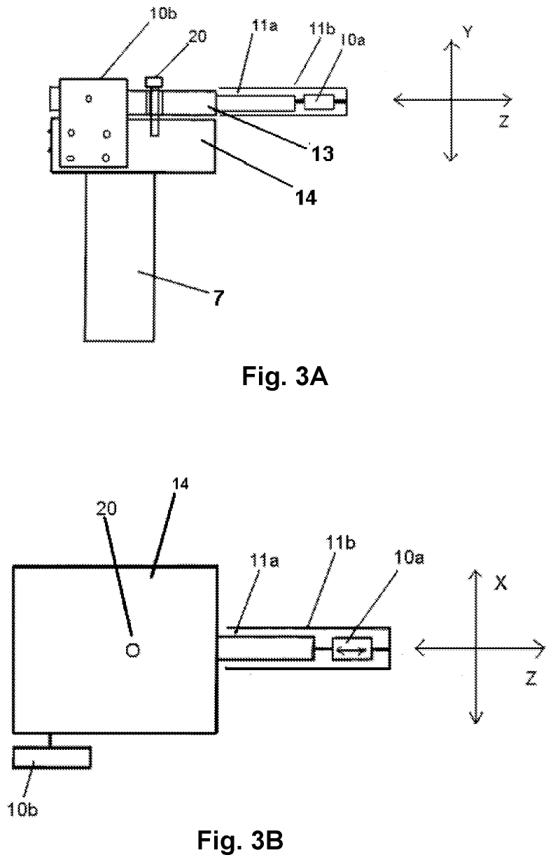

Other embodiments comprising different combinations of mechanical isolation and sensor arrangement can be conceived to provide the same result. FIG. 3 depicts another preferred embodiment. In this embodiment, the side view of a controller shown in FIG. 3A comprises just two metal plates (13, 14). The lower plate (14) is attached to a support (7) on the vehicle, such as the handle of a wheelchair. The upper plate (13) is attached to a first sensor (10b) and handle (part 11a) and has some freedom to rotate around bolt (20), subject to the application of the bolt (20) holding the two plates (13,14) in proximity. The handle contains the second sensor (10a) that is attached between the handle parts (11a) and a sliding outer handle sleeve (11b). The first sensor (10b) will therefore measure the forces in the X-axis direction only while the second sensor (10a) will measure forces in the Z-axis direction only. Both sensors (10a) and (10b) will remain unaffected by forces imparted in the Y-axis direction. As in example 1 above, leaning on the handles has no effect on the control forces in the X or Z-axis directions.

FIG. 3B illustrates a top plan view of the controller of FIG. 3A. In this view the first sensor (10b) and the second sensor (10a) can both be seen, along with the handle parts (11a) and (11b) and one of the plates (14).

The signal processor receiving the signals from the sensors can also apply a number of algorithms to ensure that the control of the vehicle is smooth, simple, safe and intuitive. The signal processor is thus adapted to operate in accordance with a predetermined instruction set.

The algorithms used can be configured, for example, to detect the tilting back of a wheelchair to allow the front ground engaging means (eg castors), followed by the main wheels, to climb over a gutter, step or other similar obstacle. On a wheelchair that has no power assist, the process is generally as follows: The wheelchair is pushed in the forward direction. On approaching a step, the attendant will stop the wheelchair before pulling back sharply on the handles. The chair tilts backwards as a result of this action. The chair can now be pushed forwards in the tilted position until the main wheels hit the step. The attendant then maneuvers the wheelchair to allow the main wheels to negotiate the step (up or down). Once the step has been negotiated the operation resumes as normal with the chair being pushed forward on the flat ground beyond the step.

The controller of the present invention may comprise further components such as an accelerometer to measure the tilt angle of the chair and a gyroscopic sensor to measure the rate at which the chair is being tilted. The algorithm in the signal processor can be configured to detect actions such as;
stopping of the wheelchair, then
the signal from the handles indicating that the attendant is pulling sharply back on the handles, then
tilting backwards of the chair, then
the tilting of the wheelchair back beyond a certain threshold angle until it is not tilted further.

If this sequence of events has been completed the signal processor may identify this condition as one where the chair is being tilted backwards by the attendant to negotiate an obstacle such as a step. The drive signal to the motors of the ground engaging members can therefore be applied appropriate to this condition. Once the controller detects that the chair has tilted forwards again normal drive for forwards travel can again be applied to the ground engaging members.

Thus the combination of signal sensors and an intelligent signal processor can be used to “understand” the intentions of the attendant and thus apply appropriate power to the ground engaging members to assist the attendant with his intended action.

Various embodiments of the invention may be embodied in many different forms, including computer program logic for use with a processor (e.g., a signal processor, microcontroller, digital signal processor, or general purpose computer and for that matter, any commercial processor may be used to implement the embodiments of the invention either as a single processor, serial or parallel set of processors in the system, programmable logic for use with a programmable logic device, discrete components, integrated circuitry, or any other means including any combination thereof).

The controller might also include a display to inform the attendant or operator of the current state of the vehicle, fault conditions and/or battery charge state.

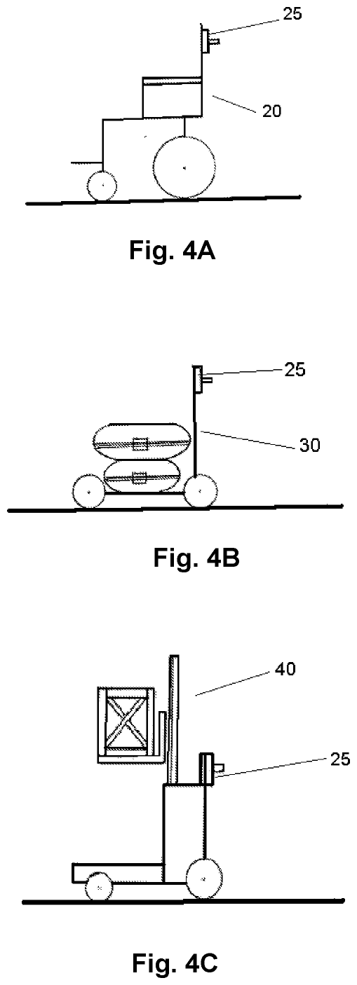

FIG. 4 illustrates three different applications of a controller (25) according to the present invention, for (a) a wheelchair (20), (b) a luggage trolley (30) and (c) a forklift (40). The controller could be used for a wide range of devices for moving people and goods, such as at airports, seaports and resorts; hospitals, nursing homes and other care facilities; warehouses and other storage facilities.

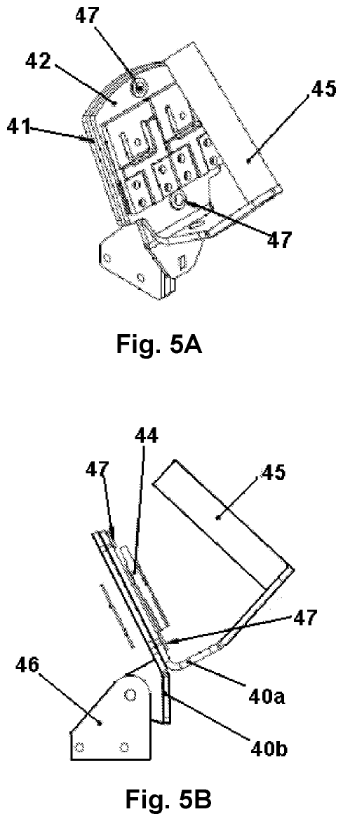

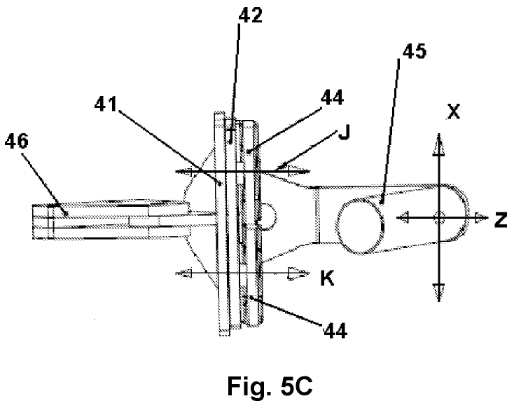

FIG. 5 illustrates a further embodiment of the device of the present invention. Specifically, in this embodiment there can be seen:
fixed base (41)
handle mounting plate (42)
loadcells (44) measuring the forces between points 41 and 42
the contact surface (45)
assembly mounting plate (46) that holds the handle assembly to the vehicle
mounting plate guide bolts (47)

The two loadcells 44 are fixed at one end to the handle mounting plate or bracket (42) and at the other end to the fixed base (41) in such a way as to measure the force between the handle mounting plate (42) and the fixed base (41). The driving force (direction Z) and steering forces (direction X) applied by the operator to the handle (45) are transferred via the handle mounting plate (42) to each of the loadcells (44). Steering and driving forces applied to the contact surface (45) in the form of a handle, are mechanically converted by the arrangement shown in FIG. 5C into forces in the J and K direction to be measured and converted to electrical signals by their respective loadcells (44)

The signals from the loadcells (44) can then be used by an electronic controller to control the drive motors of a vehicle to which they are connected. The mechanical arrangement shown in FIG. 5C illustrates the direction of the driving force in the X-axis and the steering force in the Z-axis. Forces applied in the Y-axis (ie in the vertical plane) are effectively ignored.

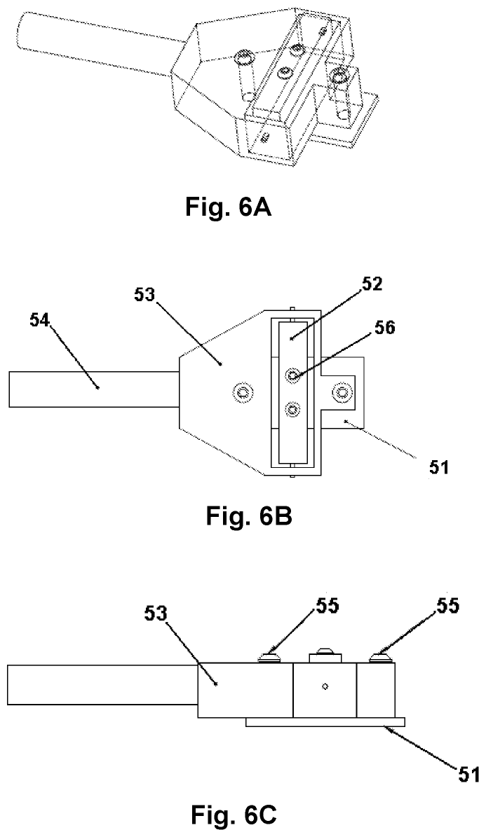

FIG. 6 illustrates an embodiment of a double ended loadcell assembly for the present invention. Specifically, in this embodiment there can be seen:
mounting base (51) fixed to the vehicle
double ended loadcell (52a, 52b) measuring the forces on the handle (54)
connecting frame (53)
contact surface (54)
handle body guide bolts (55) (see FIG. 6C)
loadcell fixing bolts (56)

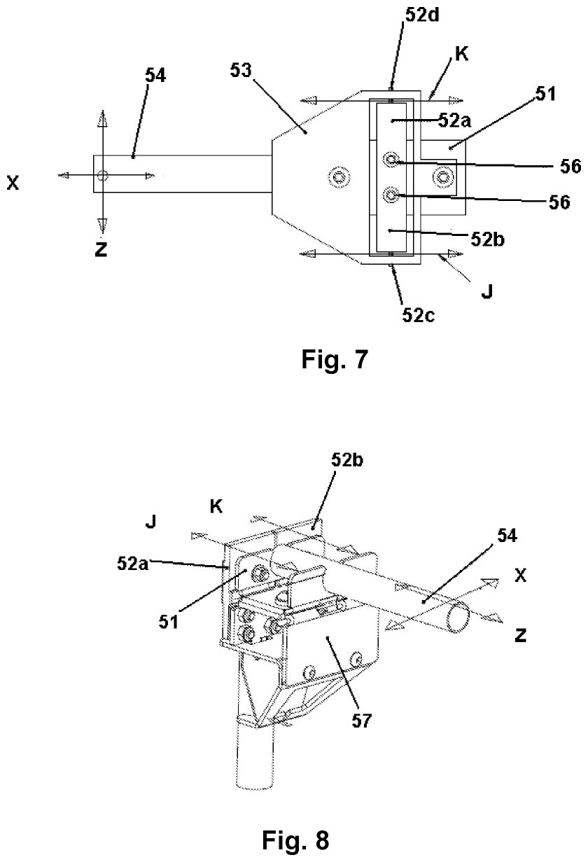

FIG. 7 illustrates the operation in further detail. The double ended loadcell (52a, 52b) is fixed to the mounting base (51) by the fixing bolts (56). The driving forces (X direction) and steering force (Z direction) applied by the operator on the handle (54) are transferred via the connecting frame (53) to each of the loadcell measuring elements (52a, 52b) by the connecting pins (52c, 52d). Steering and driving forces applied to the contact surface (54) are mechanically converted by the arrangement shown in FIG. 7 into forces in the J-direction and K-direction to be measured and converted to electrical signals by the respective load cell elements (52a, 52b).

The signals from the loadcells (52a, 52b) can be used by an electronic controller to control the drive motors of the vehicle to which it is connected. The mechanical arrangement of FIG. shows the driving force in the X-axis and the steering force in the Z-axis. Forces applied in the Y-axis (ie in the vertical plane) are effectively ignored.

FIG. 8 illustrates operation of a further embodiment of the handle. The two load cells (52a, 52b) are fixed at one end to the handle bracket (51) and at the other end to the mounting base (57) in such a way as to measure the force between the handle bracket (51) and the mounting base (57). The driving and steering forces applied by the operator on the contact surface (54) are transferred via the handle bracket (51) to each of the loadcells (52a, 52b). Steering and driving forces applied to the contact surface (54) are mechanically converted by the arrangement shown in FIG. 8 in to forces in the direction of the arrows (J and K) to be measured and converted to electrical signals by loadcell elements (52a, 52b) respectively.

The signals form the loadcells (52a, 52b) can then be used by an electronic controller to control the drive motors of the connected vehicle. The mechanical arrangement of FIG. 8 illustrates how the driving force in the X-axis direction (X) and Y-axis direction are effectively ignored.

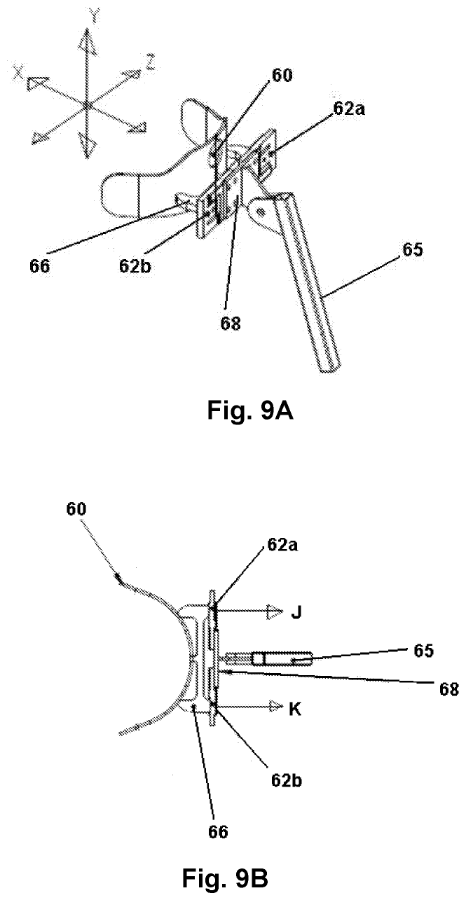

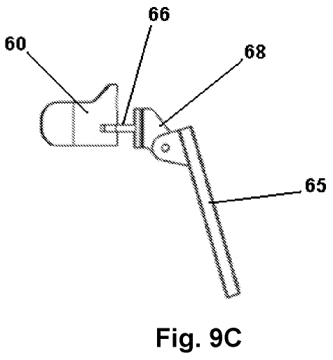

FIG. 9 illustrates an embodiment of a head operated controller according to the present invention. In this embodiment the contact surface is adapted for contact with the operator's head and is appropriately curved to comfortably fit the rear of the operator's skull.

The controller is mounted at one end of a mounting pole (65) in a position to allow the operator to place the back of their head against the contact surface (60) in the form of a headrest. The other end of the mounting pole (65) is connected to a wheelchair or other vehicle. The wheelchair steering can be controlled by the operator pushing their head to the left or right against the contact surface (60) to direct the wheelchair to the left or right respectively. The drive speed can be controlled by the amount of pressure imparted by the user's head directly against the contact surface (60) in the X direction.

Two loadcells (62a, 62b) are each mounted with one end fixed to the mounting plate (68) and at the other end fixed to the headrest bracket (66). This mounting arrangement allows the driving and steering forces applied by the operator on the contact surface (60) of the headrest to be transferred via the headrest bracket (66) to each of the loadcells (62a, 62b). Using this arrangement the steering and driving forces are mechanically converted into Forces J and K to be measured and converted to electrical signals by the respective loadcells (62a, 62b).

The signals from the loadcells (62a, 62b) can then be used by an electronic controller to control the drive motors of the connected wheelchair or other vehicle. The mechanical arrangement shown in FIG. 9 illustrates the driving force in the X-axis direction and the steering force in the Z-axis direction. Forces applied in the Y-axis direction (ie in the vertical plane) are effectively ignored.

Drive force can only be applied in one direction with the arrangement shown in FIG. 9. As an added feature, a pushbutton switch could be mounted to protrude through the hole in the contact surface (60) of the headrest in such a way that the operator can change the drive direction by operating the switch with their head.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features set out above.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language. Moreover, there are hundreds of available computer languages that may be used to implement embodiments of the invention.

The computer program may be fixed in any form (e.g., source code form, computer executable form, or an intermediate form) either permanently or transitorily in a tangible storage medium, such as a semiconductor memory device, a magnetic memory device, an optical memory device, a PC card, or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic implementing all or part of the functionality where described herein may be designed using traditional manual methods, or may be designed, captured, simulated, or documented electronically using various tools, such as Computer Aided Design (CAD), a hardware description language, or a PLD programming language. Hardware logic may also be incorporated into display screens for use with the invention and which may be segmented display screens, analogue display screens, digital display screens, CRTs, LED screens, Plasma screens, liquid crystal diode screen, and the like.

Programmable logic may be fixed either permanently or transitorily in a tangible storage medium, such as a semiconductor memory device, a magnetic memory device, an optical memory device, or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation, preloaded with a computer system, or distributed from a server or electronic bulletin board over the communication system.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A controller for operative connection to a power assisted transport vehicle that is at least partially directed by a human operator in physical contact with the vehicle, the controller including:
a contact surface,
a first sensor and a second sensor each responsive to actuation of the contact surface, each sensor having a respective first sensor output signal and a second sensor output signal, and
a signal processing means adapted to process the first and second output signals,
wherein force imparted to the contact surface in the Z-axis is adapted to provide Z-axis movement of the vehicle by processing the first sensor output signal and the second sensor output signal, and
wherein force imparted to the contact surface in the X-axis is adapted to provide X-axis movement of the vehicle by processing the first sensor output signal and the second sensor output signal.

2. The controller according to claim 1 wherein the contact surface is chosen from the group comprising a handle, joystick, contact pad or headrest.

3. The controller according to claim 1 wherein the actuation comprises physical force imparted by a body part of the operator.

4. The controller according to claim 1 wherein the actuation of the contact surface occurs when physical force is imparted by a body part.

5. The controller according to claim 4 wherein the body part is chosen from the hand, head, arm, shoulder, finger or leg of the operator.

6. The controller according to claim 1, the controller having a single contact surface.

7. The controller according to claim 1, the controller having a third sensor and a fourth sensor each responsive to actuation of the contact surface, and having a respective third sensor output signal and fourth sensor output signal wherein the signal processing means being adapted to process output signals of all the sensors.

8. The controller according to claim 1 comprising a further sensor, wherein force imparted to the contact surface in the Y-axis is adapted to provide a further sensor output signal to enable a further predetermined function of operation.

9. The controller according to claim 1 comprising a further sensor, wherein force imparted to the contact surface in the Y-axis is adapted to provide a further sensor output signal to enable Y-axis movement of at least part of the vehicle.

10. The method of controlling a power assisted transport vehicle that is at least partially directed by a human operator in physical contact with the vehicle using the controller of claim 1, the method including the step of applying force to the contact surface to control the direction and speed of the vehicle.

11. The method according to claim 10 wherein the force applied is manual force.

12. The controller according to claim 1 when used for a vehicle chosen from the group comprising electric wheelchairs, forklifts, luggage trolleys, goods trolleys and golf bag buggies.

13. The power assisted transport vehicle comprising the controller of claim 1 wherein the controller is in operative connection with the transport vehicle being at least partially directed by a human operator in physical contact with the vehicle.
